(19) United States
(12) Patent Application Publication
(10) Pub. No.: US 2020/0111135 A1
(43) Pub. Date: Apr. 9, 2020

(54) MARKETING CAMPAIGN COLLABORATION SYSTEM AND METHOD

(71) Applicant: rewardStyle, Inc., Dallas, TX (US)

(72) Inventors: Baxter Box, Dallas, TX (US); Amber Venz Box, Dallas, TX (US); Vijai Viswanathan, Carrollton, TX (US)

(73) Assignee: rewardStyle, Inc., Dallas, TX (US)

(21) Appl. No.: 16/593,720

(22) Filed: Oct. 4, 2019

Related U.S. Application Data
(60) Provisional application No. 62/741,233, filed on Oct. 4, 2018.

(51) Int. Cl. G06Q 30/02; G06Q 50/00

(52) U.S. Cl. CPC G06Q 30/0276; G06Q 50/01; G06Q 30/0201

(57) ABSTRACT

A system for data management comprising a campaign data management system operating on a processor and configured to receive data identifying products and sales for each of a plurality of influencers. A campaign creation system operating on a processor and configured to receive a plurality of campaign rules from a user and to provide the plurality of campaign rules to the campaign data management system. Wherein the campaign data management system is configured to identify a subset of the plurality of influencers as a function of the plurality of campaign rules and the data identifying products and sales and to provide the subset of the plurality of influencers to an influencer selection system operating on a processor.

### RELATED APPLICATIONS

The present application claims priority to and benefit of U.S. Provisional Patent Application No. 62/741,233, filed Oct. 4, 2018, which is hereby incorporated by reference for all purposes as if set forth herein in its entirety.

### TECHNICAL FIELD

The present disclosure relates generally to online marketing, and more specifically to a marketing campaign collaboration system and method that facilitates the identification of specific social media influencers for a marketing campaign.

### BACKGROUND OF THE INVENTION

While many general purpose collaboration tools exist, there are numerous problems in specialized applications for collaboration that the existing tools do not solve. Many of these problems are not even recognized.

### SUMMARY OF THE INVENTION

A system for data management is provided that includes a campaign data management system operating on a processor and configured to receive data identifying products and sales for each of a plurality of influencers. The system further includes a campaign creation system operating on a processor and configured to receive a plurality of campaign rules from a user and to provide the plurality of campaign rules to the campaign data management system. The campaign data management system is configured to identify a subset of the plurality of influencers as a function of the plurality of campaign rules and the data identifying products and sales and to provide the subset of the plurality of influencers to an influencer selection system operating on a processor.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for campaign data management, in accordance with an example embodiment of the present disclosure;

FIG. 2 is a diagram of a system for campaign data management showing campaign creation data flows, in accordance with an example embodiment of the present disclosure;

FIG. 3 is a diagram of a system for campaign data management showing campaign posting data flows, in accordance with an example embodiment of the present disclosure;

FIG. 4 is a diagram of a system for campaign data management showing campaign tracking data flows, in accordance with an example embodiment of the present disclosure; and

FIG. 5 is a diagram of a system for campaign data management showing campaign completion data flows, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

Online marketing and sales (“virtual retail operations”) are significantly different from prior art “brick and mortar” marketing and sales (“physical retail operations”), and have new problems that cannot be addressed by existing collaboration tools for such physical retail operations. For example, virtual retail operations must get information about new products to consumers that are looking at a computer screen, but physical retail operations can create displays of products throughout a store, and allow consumers to walk through the store and not only look at the displays but immediately try on the products that are on display. To create the displays, physical retail operations hire employees that stage the displays, which typically include manikins on which articles of clothing and accessories have been arranged. While pictures of such displays can be created and provided by virtual retail operations, it can be difficult to direct a potential buyer to such pictures, or to otherwise provide such pictures in a manner that attracts viewers.

To solve this problem, innovators such as rewardStyle developed social media marketing techniques that allow a user to create their own displays and to use their social media contacts to reach potential buyers. These users or “influencers” typically create their own displays by taking a picture of themselves wearing clothing and accessories, and then linking the picture to websites where the articles of clothing or accessories can be obtained. The picture is then posted on social media, such as blog posts, Twitter, Facebook, Instagram, Snapchat, Google+ and other social media platforms that presently exist or that may be developed, and infrastructure systems and methods that have been developed by rewardStyle can be used to allow the influencers to be compensated when a buyer “clicks through” to the website from the social media post.

Even though this innovative process adds significantly more to the prior art physical retail operations process, it does not solve all of the problems associated with virtual retail operations. For example, physical retail operations have buyers that travel to manufacturers, fashion shows and the like to identify new products of interest, and then orders are placed for those new products and are shipped in bulk to the physical retail operations, where they are stored until sold. This process cannot be used for virtual retail operations, because the influencers will not engage in such pre-market activities. Thus, if a manufacturer or designer (also referred to generally as a “brand”) wants to produce and market a new product for virtual retail operations, they must typically first develop and market the product for physical retail operations and wait for it to be identified and utilized by an influencer. As a result, the best influencer for a new product might not see a new product, and virtual retail operation sales for the new product might be depressed as a result.

In order to solve this new problem created by the new virtual retail operations environment, a collaboration system is needed that allows brands to identify influencers in advance of mass production, and to coordinate with those influencers to engage in marketing for virtual retail operations. In order to identify such influencers, brands need to be able to see information that is created by the influencer on social media that the influencers operate on, examples of social media posts by the influencer, historical sales data for the influencer and other suitable data. Because this data can be voluminous and difficult to collate, additional tools are needed to select the most suitable influencers for a given brand. For example, an influencer might have a large number of brands that they have worked with or currently work with, but might focus primarily on a small number of brands at any given time, such as based on a season, an event or so forth. The disclosed collaboration portal is in a unique position to determine that information and to select a subset of influencers for brands that are most likely to be interested in working with the brand on marketing a new product. The brand can then select a smaller subset of influencers and make an offer to those influencers to assist with a marketing campaign that has a number of predetermined components, such as a number of types of posts (e.g. video, blog entries, displays) on a number of different types of social media (e.g. Facebook, Instagram, Snapchat). The influencers can then provide evidence that goals associated with these components have been met, such as a number of posts, a number of views and so forth, and can be automatically compensated after they have met the goals. The portal or brand can also audit the evidence to ensure that quality standards are being met, to review third party feedback on the posts and for other suitable purposes. Based on the results of the collaboration, the brands can then decide whether to further produce and market a new product, to modify the product based on the feedback or to take other suitable actions.

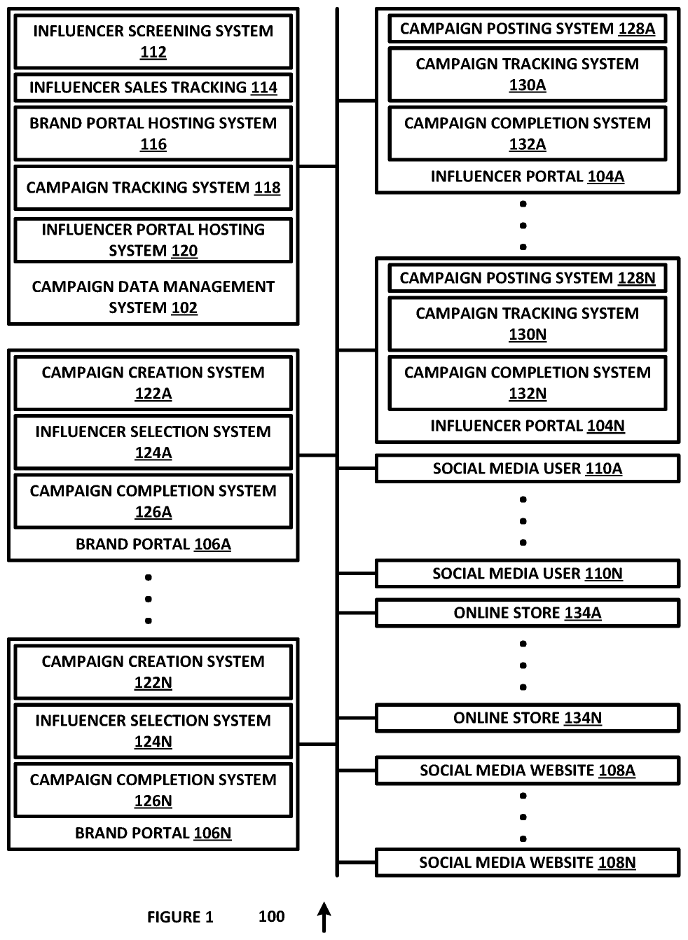

FIG. 1 is a diagram of a system 100 for campaign data management, in accordance with an example embodiment of the present disclosure. System 100 includes campaign data management system 102, which further includes influencer screening system 112, influencer sales tracking system 114, brand portal hosting system 116, campaign tracking system 118 and influencer portal hosting system 120, brand portal systems 106A through 106N, which include campaign creation systems 122A through 122N, influencer selection systems 124A through 124N and campaign completion systems 126A through 126N, respectively, influencer portals 104A through 104N, which include campaign posting systems 128A through 128N, campaign tracking systems 130A through 130N and campaign completion systems 132A through 132N, respectively, social media users 110A through 110N, online stores 134A through 134N and social media websites 108A through 108N, each of which can be implemented in hardware or a suitable combination of hardware and software, and which can be one or more software systems operating on a suitable special purpose hardware platform.

Campaign data management system 102 includes a plurality of algorithms that allow a diverse number of different special purpose processing platforms in a diverse number of locations to provide functionality that does not exist in processing platforms that are not configured to operate in accordance with the present disclosure. These algorithms transform the special purpose processors into systems that have specific and substantial utility, and add the ability or provide significantly more than prior art systems for buying and selling goods over a network, as discussed further herein, as is generally similar to the algorithms used by other systems that transform the special purpose processors of those other systems into systems that have specific and substantial utility, as will be recognized by a person of ordinary skill in the art through this specification without further repetition.

Influencer screening system 112 implements a plurality of algorithms that allow a subset of influencers to be identified that are optimal influencers for a specific brand. In one example embodiment, the algorithms implemented by influencer screening system 112 can track influencers by a predetermined number of metrics, including but not limited to total sales for a specific brand, total sales for a specific class of item (such as clothing type, clothing function, accessory type, accessory function and so forth), seasonal sales for a brand or class of item and so forth. Influencer screening system 112 allows influencers for a proposed campaign to be identified based on one or more criteria identified by a user through brand portal 106A through 106N, and also based on one or more internal criteria that are tracked by campaign data management system 102 but which are not made available to a user of brand portal 106A through 106N. In this manner, the number of candidate influencers for a campaign can be based on non-public information, such as sales information that is of a confidential nature, which protects the sales information from disclosure to third parties but which allows the sales information to be used to generate derivative data that is provided to third parties, thus providing significantly more than prior art database systems that allow users to search data but which make that data public and difficult or impossible to protect.

Influencer sales tracking system 114 implements a plurality of algorithms that track sales made by influencers in response to a social media post created by the influencer. In one example embodiment, the algorithms implemented by influencer sales tracking system 114 can track sales of different items by the same brand made at one or more online stores, can track sales of the same item made by different brands and at one or more online stores, can track sales made by different social media posting types, total commissions made, total commissions refunded due to returns, sales made as a function of season or event or other suitable sales data that allow influencers to be analyzed for potential inclusion in a campaign, thus providing significantly more than prior art database systems that allow users to search data but which do not allow data to be tracked. In addition, social media data can also be used in addition to the influencer sales data, such as to provide campaign level reporting on a number of impressions or clicks, including whether or not an impression or click drove a sale. A number of followers of an influencer, comments on their images and other related data can also be correlated to an influencer to allow brands to make sure they are making the correct decisions in which influencer to cast.

Brand portal hosting system 116 implements a plurality of algorithms that create a brand portal with a plurality of user controls to allow a campaign to be submitted to campaign data management system 102 for subsequent processing. In general, the diagrams of FIGS. 1 through 5 show user controls for users of associated systems that perform the disclosed functionality, which can be generated in a user interface display to allow the user to review data displays that are described herein and to make selections of functions, define functions, change a status or perform other actions that cause the disclosed systems to change a functional state or to perform a disclosed function.

In one example embodiment, a campaign can include a predetermined number of items, a predetermined number of different social media, a predetermined time period, a predetermined financial compensation and so forth, to allow a user that is representing a brand to identify a predetermined set of criteria for use in selecting influencers, thus providing significantly more than prior art database systems that allow users to search data but which do not allow campaigns to be created or monitored.

Campaign tracking system 118 implements a plurality of algorithms that track the performance of a predetermined number of tasks associated with a campaign. In one example embodiment, the algorithms can track a number of social media posts made and the location of the social media posts, the content of the social media posts, campaign requirements and other suitable data and can determine whether social media posts identified by an influencer meet predetermined criteria that have been identified by a user associated with a brand. In this example embodiment, a brand rule for a social media post can include a requirement regarding a type of post, the content of the post, words used in the post and so forth, and campaign tracking system 118 can analyze each social media post to determine whether it complies with the predetermined criteria, thus providing significantly more than prior art database systems that allow users to search data but which do not allow campaigns to be created or tracked.

Influencer portal hosting system 120 implements a plurality of algorithms that create an influencer portal with a plurality of user controls to allow a campaign to be reviewed, accepted and performed by an influencer. In one example embodiment, an influencer can be identified by campaign data management system 102 to one of brand portal systems 106A through 106N, and upon acceptance of the influencer as a prospective influencer, influencer portal hosting system 120 can generate a portal having a plurality of user controls that allow the influencer to review the campaign proposal and to accept, reject or submit a counter proposal to the campaign proposal. The proposal can be configured to be automatically implemented by campaign data management system 102 or other suitable systems, such as to allow the campaign criteria to be automatically used to configure campaign completion rules, such as to allow campaign completion to be automatically determined by social media post type and number, content, terminology and other suitable data. In this manner, when a proposal is accepted, the proposal can be implemented without further user involvement. Likewise, any counter proposals can includes specific modifications to the types of social media, the number of posts, the media content of posts, the terminology that must be used in the posts and so forth, to allow the counter proposal to be automatically implemented upon acceptance, thus providing significantly more than prior art database systems that allow users to search data but which do not allow proposals and counter proposals to be automatically implemented as a campaign.

Brand portal systems 106A through 106N each implements a plurality of algorithms that create a plurality of user controls to allow a user representing a brand to create and submit a campaign, to approve a proposed influencer, to accept counter proposals and to review and accept campaign completion data, such as to allow the influencer to receive payment for the campaign. In one example embodiment, the algorithms implemented by brand portal systems 106A through 106N enable the user to identify a number of social media posts, types of social media posts, content of social media posts, terminology for social media posts, profile characteristics for influencers and other suitable data to define a campaign, can approve or deny proposed influencers, can review and approve, deny or submit a counter-counter proposal, and to otherwise create and monitor completion of a campaign in a manner that does not require additional user interaction to implement, thus providing significantly more than prior art database systems that allow users to search data but which do not allow parties to automatically implement proposals and counter proposals for a marketing campaign.

Campaign creation systems 122A through 122N each implements a plurality of algorithms that allow a user affiliated with a brand to develop a marketing campaign for use in identifying one or more influencers, including social media posting types and requirements that the influencer must agree to satisfy in order to receive proposed compensation. In one example embodiment, campaign creation systems 122A through 122N can be implemented as an application, a mobile application, a thin client, a web browser page, a cloud computing service or in other suitable manners, and can generate a number of example campaigns, proposed campaign templates, social media exemplars or other suitable data that can be selected and modified by a user and added to a campaign file or document, to allow the user to create rules for social media posts (such as types of products that can be included and that must be omitted, specific words to use and to avoid, number of posts or post length information and so forth), to review the campaign rules or requirements, to estimate a number of views that should be generated, to estimate a conversion rate between social media views and purchases, and to otherwise evaluate the impact of a proposed campaign, thus providing significantly more than prior art database systems that allow users to search data but which do not allow parties to automatically see estimates of potential future activity such as views and sales for a marketing campaign.

Influencer selection systems 124A through 124N each implements a plurality of algorithms that allow a user affiliated with a brand to view a number of predetermined influencers, examples of their social media posts, statistics related to their social media followers, statistics related to the product sales associated with their social media posts and so forth. In one example embodiment, the algorithms implemented by influencer selection systems 124A through 124N can receive data from influencer screening system 112, influencer sales tracking system 114 and other suitable systems that define historical performance metrics for a plurality of different influencers, examples of social media posts for each influencer, types of social media used by the influencer and other suitable data to allow the user to select proposed influencers for a marketing campaign, thus providing significantly more than prior art database systems that allow users to search data but which do not allow parties to interactively review external data such as social media posts and confidential information such as sales associated with a social media post for use in a marketing campaign.

Campaign completion systems 126A through 126N each implement a plurality of algorithms that allow a user associated with a brand to confirm that campaign objectives have been met before approving payment to an influencer. In one example embodiment, campaign tracking system 118 or other suitable systems can provide data associated with a campaign that has already been automatically analyzed to determine compliance with the campaign rules specified using campaign creation systems 122A through 122N, and can allow a user to manually confirm compliance with rules, to reject submitted fulfillment requirements that did not meet the rules or to otherwise accept completion of campaign requirements for an influencer, thus providing significantly more than prior art database systems that allow users to search data but which do not allow parties to interactively review external data such as social media posts and confidential information such as sales associated with a social media post for use in confirming completion of a marketing campaign.

Influencer portals 104A through 104N each implements a plurality of algorithms that allow an influencer to participate in marketing campaigns and to receive compensation in the form of commissions for sales as well as incentives from brands for specific type and numbers of social media posts. In one example embodiment, the algorithms implemented by influencer portals 104A through 104N can be implemented as an application, a mobile application, a thin client, a web browser page, a cloud computing service or in other suitable manners, and can include a number of user controls that allow the influencer to perform predetermined actions in response to marketing campaign proposals and requirements, thus providing significantly more than prior art database systems that allow users to search data but which do not allow parties to interactively review campaign proposals and to accept the terms of a proposal and to make counter proposals for a marketing campaign.

Campaign posting systems 128A through 128N each implement a plurality of algorithms that allow an influencer to review a proposed marketing campaign and to accept the proposal, submit counter proposals, agree to a marketing campaign or perform other suitable actions. In one example embodiment, the algorithms implemented by campaign posting systems 128A through 128N can enable the influencer to see campaign rules such as proposed product information, social media post requirements, text and content restrictions and other suitable campaign data and can accept the proposed campaign, modify one or more of the proposed campaign rules as a counter proposal, reject the campaign offer or otherwise respond to the campaign proposal, thus providing significantly more than prior art database systems that allow users to search data but which do not allow parties to interactively review campaign rules and to modify the rules for a counter proposal in a marketing campaign.

Campaign tracking systems 130A through 130N each implement a plurality of algorithms that enforce a plurality of different rules for a campaign. In one example embodiment, campaign tracking systems 130A through 130N can generate one or more user controls that allow an influencer to submit a proposed social media post for approval prior to posting, to review the associated campaign rules, to edit the social media posts in response to non-compliance reports, to submit potentially compliant social media posts and to otherwise track social media campaign performance, thus providing significantly more than prior art database systems that allow users to search data but which do not allow parties to interactively submit social media posts for automated rule compliance analysis and obligation tracking in a marketing campaign.

Campaign completion systems 132A through 132N each implement a plurality of algorithms that allow a user affiliated with a brand to verify that all requirements of a campaign have been successfully completed. In one example embodiment, the algorithms implemented by campaign completion systems 132A through 132N can generate a plurality of user controls that can alert a user when one or more campaigns have been submitted as complete, and which allow the user to review one or more social media postings associated with the campaign as well as a chart comparing campaign obligations to completed submissions. The user controls also allow a user to review social media posts on the same screen with campaign rules, to respond to or reject posts that are non-compliant and to provide feedback to the associated influencer, thus providing significantly more than prior art database systems that allow users to search data but which do not allow parties to interactively review social media posts for rule compliance analysis and to provide responses with additional obligations in a marketing campaign.

Social media users 110A through 110N each implement a plurality of algorithms that allow a user to browse a social media website, such as using an application, a thin client, a web browser page or other suitable functionality. Each social media user 110A through 110N can interface with one or more of social media websites 108A through 108N, and can review posts made by influencers using influencer portals 104A through 104N that were made in conjunction with a campaign. A social media user can make a purchase from one or more of online stores 134A through 134N in response to data obtained from the posts, which can result in commission payments to the influencers that made the posts. The commission payments can include a number of components, such as a commission paid to the influencer for a sale from the merchant, a commission paid to the influencer from the brand, or other suitable commission components. In addition, campaign data management system 102 and influencer sales tracking 114 can track the sales, the commissions and other suitable data for use in assisting brands with creation of campaigns.

Online stores 134A through 134N each implement a plurality of algorithms that allow a user to view and purchase items. In one example embodiment, the algorithms implemented by online stores 134A through 134N can be associated with an affiliate network and can generate sales information, commission information and other data associated with the sale based on data stored in a data memory, which can be provided in a data message to campaign data management system 102, influencer sales tracking system 114 and other suitable systems. Also or alternatively, online stores 134A through 134N can utilize hypertext transfer protocol (HTTP) data that can be used to provide sales, commission and other suitable data to campaign data management system 102, influencer sales tracking system 114 and other suitable systems.

Social media websites 108A through 108N each implement a plurality of algorithms that allow users to make their own postings and to review the posting of others. The algorithms implemented by social media websites 108A through 108N can have specific functionality, such as application-based post review functionality, website-based post review functionality, additional functionality that can be used by an influencer or campaign data management system 102 to track sales made to online stores in response to a post by an influencer user of social media websites 108A through 108N, or other suitable data.

In operation, system 100 allows an influencer to make social media posts that can be used by others to locate clothing, accessories and other items for purchase, and can direct viewers of the influencer's social media posts to online stores where the items can be purchased. The influencer can then receive a commission following a sale, minus a deduction for any returns. Campaign data management system 102 can track such sales and associated data regarding the brand of the item that was sold, the number of items sold, the commissions made, increases or decreases in sales for different items or brands as a function of time, increases or decreases in numbers of social media followers, sales or commissions as a percentage of social media followers, associated purchases and other suitable data, which can be used by campaign data management system 102 to identify influencers for a campaign in response to campaign data received from brand portals 106A through 106N. System 100 thus allows campaign data management system 102 to control access to sales data for individual influencers, and also allows campaign data management system 102 to evaluate the sales data using proprietary and confidential processes to identify the most suitable influencers for a sales campaign. In this manner, a brand does not need to search through a large database of influencers to look for irrelevant data such as a number of social media followers, and can instead receive a subset of the most relevant influencers for a campaign. System 100 thus provides significantly more than prior art systems that only provide such irrelevant data or which are not capable of accessing sales and commission data for a large number of different influencers at a large number of different online retailers that are selling products associated with a large number of different brands.

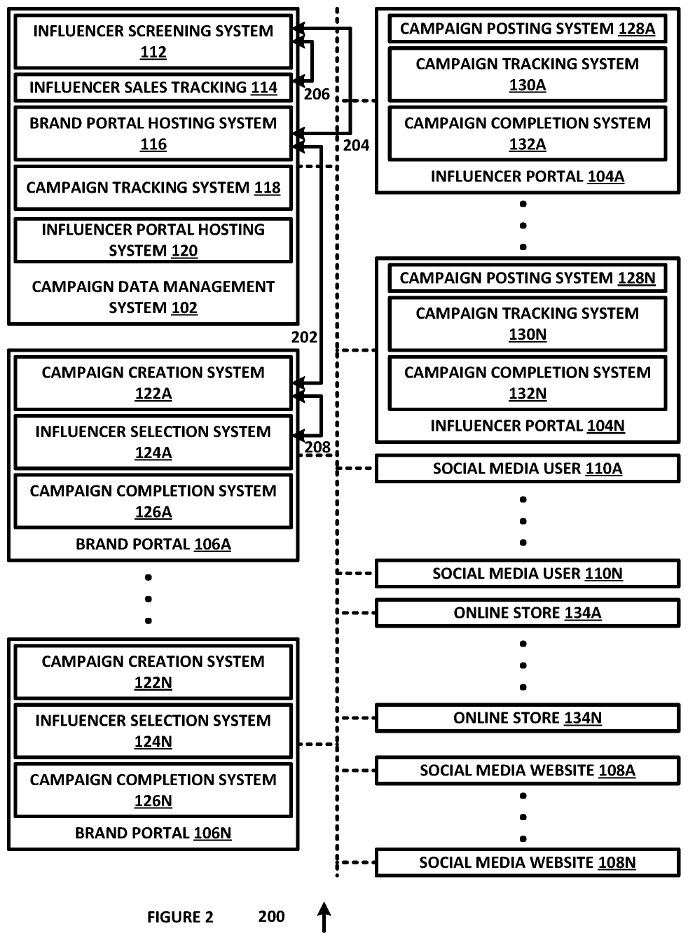

FIG. 2 is a diagram of a system 200 for campaign data management showing campaign creation data flows, in accordance with an example embodiment of the present disclosure. The data flow paths of system 200 can be implemented by one or more algorithms, and are several of a large number of different data flow paths that can be implemented using the algorithms disclosed herein. The data flow paths allow data to be exchanged between two or more systems to allow described functions to be performed at a specific time and in a specific order, and thus present a significant improvement over prior art systems that only use a subset of the described functions or that fail to perform the described functions in the proper order and result in incomplete data sets and ineffective and wasteful use of resources.

System 200 includes example data flow path 202 between brand portal hosting system 116 and campaign creation system 122A, which can be formed by one or more algorithms as part of a first process of creating a proposed campaign. Data flow path 202 allows a campaign creation user interface to be generated for a user affiliated with a brand, such as to see template campaigns, to upload a brand-specific campaign, to receive statistics related to a proposed campaign (such as historical brand sales through the identified sales channels) and other suitable data. In this example, the statistics can be provided by influencer screening system 112 through data flow path 204 and/or by influencer sales tracking system 114 through data flow path 206. Data flow path 208 can then be used to allow the user affiliated with the brand to select from a subset of all influencers that are selected by campaign data management system 102 and its associated sub-systems using one or more algorithms, including but not limited to algorithms that identify the influencers with the greatest percentage increase in sales for a specific item type over a predetermined time period, the influencers with the highest persistent sales for a specific item type over a predetermined time period, the influencers with the greatest percentage increase in sales for a specific item type associated the same brand or a different brand over a predetermined time period, the influencers with the highest persistent sales for a specific item type associated with the same brand or a different brand over a predetermined time period, the influencers with the highest persistent sales for an unrelated item type associated with the same brand or a different brand over a predetermined time period that has been determined to be of potential interest to a buyer using data mining or other suitable influencer selection algorithms. Data flows 202, 204, 206 and 208 are algorithms that provide significantly more than prior art processes for identifying influencers, which use irrelevant data such as a number of followers that cannot accurately predict the success of a campaign, and which can result in ineffective identification of influencers for campaigns.

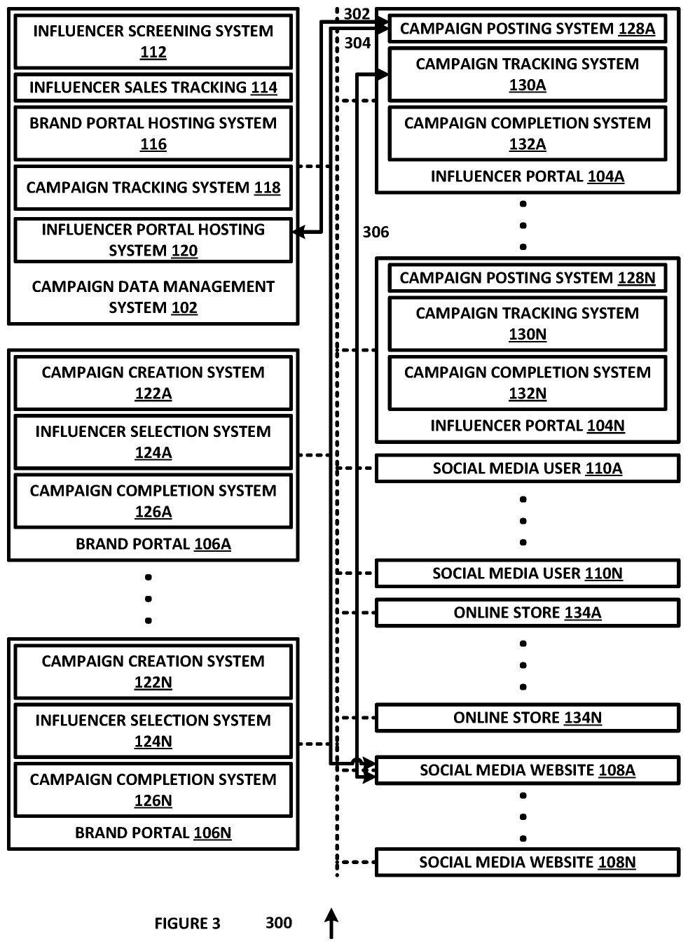

FIG. 3 is a diagram of a system 300 for campaign data management showing campaign posting data flows, in accordance with an example embodiment of the present disclosure. The data flow paths of system 300 can be implemented by one or more algorithms, and are several of a large number of different data flow paths that can be implemented using the algorithms disclosed herein. The data flow paths allow data to be exchanged between two or more systems to allow described functions to be performed at a specific time and in a specific order, and thus present a significant improvement over prior art systems that only use a subset of the described functions or that fail to perform the described functions in the proper order and result in incomplete data sets and ineffective and wasteful use of resources.

Data flow path 302 can be formed by one or more algorithms and allows data to be exchanged between influencer portal hosting system 120 and campaign posting system 128A, which are two of a large number of associated systems that can implement the disclosed algorithms. Influencer portal hosting system 120 can generate one or more user interface controls to allow a user at campaign posting system 128A to review a proposed campaign, make a counter proposal, accept a current proposal or to perform other suitable functions associated with campaign proposal review and approval as described herein.

Data flow path 304 can be formed by one or more algorithms and allows data to be exchanged between campaign posting system 128A and social media website 108A, which are two of a large number of associated systems that can implement the disclosed algorithms. A user at campaign posting system 128A can use one or more rules associated with a campaign to create a social media post for social media website 108A. In one example embodiment, campaign posting system 128A can implement algorithms that review content in a social media post for compliance with campaign rules, and which provide additional related functions as described herein.

Data flow path 306 can be formed by one or more algorithms and allows data to be exchanged between campaign tracking system 130A and social media website 108A, which are two of a large number of associated systems that can implement the disclosed algorithms. A user at campaign tracking system 130A can use one or more rules associated with a campaign to track social media posts at social media website 108A. In one example embodiment, campaign tracking system 130A can implement algorithms that track content in a social media post for compliance with campaign rules, and which provide additional related functions as described herein.

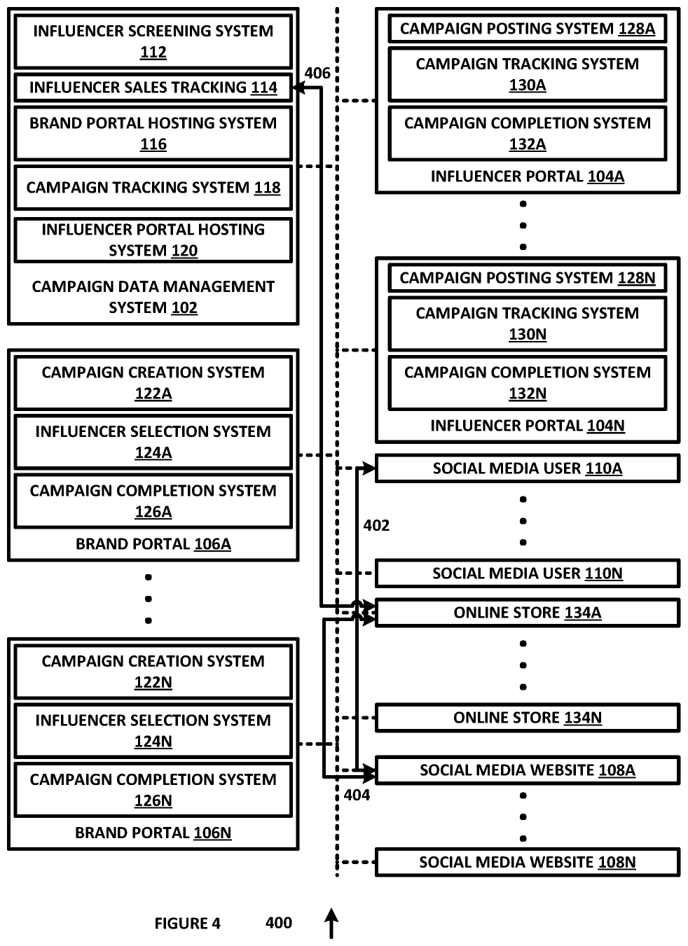

FIG. 4 is a diagram of a system 400 for campaign data management showing campaign tracking data flows, in accordance with an example embodiment of the present disclosure. The data flow paths of system 400 can be implemented by one or more algorithms, and are several of a large number of different data flow paths that can be implemented using the algorithms disclosed herein. The data flow paths allow data to be exchanged between two or more systems to allow described functions to be performed at a specific time and in a specific order, and thus present a significant improvement over prior art systems that only use a subset of the described functions or that fail to perform the described functions in the proper order and result in incomplete data sets and ineffective and wasteful use of resources.

Data flow path 402 can be formed by one or more algorithms and allows data to be exchanged between social media user 110A and social media website 108A, which are two of a large number of associated systems that can implement the disclosed algorithms. In one example embodiment, social media user 110A can be a follower of an influencer that used campaign posting system 128A or other suitable systems to make a social media post that includes predetermined data that allows the social media user to purchase an item from an online store.

Data flow path 404 can be formed by one or more algorithms and allows data to be exchanged between social media website 108A and online store 134A, which are two of a large number of associated systems that can implement the disclosed algorithms. In one example embodiment, once a social media user has decided to make a purchase from an online store 134A based on content posted to a social media website 108A, an HTTP link or other suitable control can be used to direct the user to online store 134A or other suitable locations. As such, while data flow path 404 is shown as involving social media website 108A and online store 134A, one or more additional systems can also or alternatively be used as part of the algorithm associated with data flow path 404, including social media user 110A and campaign data management system 102 or its associated sub-systems.

Data flow path 406 can be formed by one or more algorithms and allows data to be exchanged between online store 134A and influencer sales tracking system 114, which are two of a large number of associated systems that can implement the disclosed algorithms. In one example embodiment, online store 134A can be part of an affiliate network and can generate data for transmission to influencer sales tracking system 114 that identifiers the influencer, the items sold, associated commissions and other suitable data. In another example embodiment, HTTP data generated and used by social media user 110A, social media website 108A, influencer portal 104A, campaign data management system 102 and others can be used to identify items, sales, commissions and so forth, or other suitable functionality can be used.

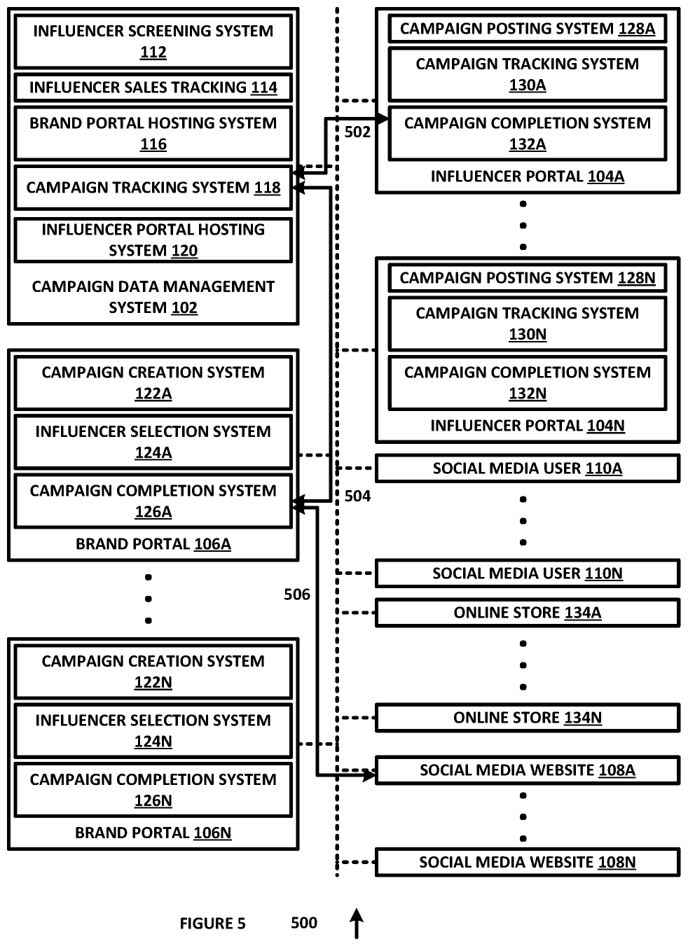

FIG. 5 is a diagram of a system 500 for campaign data management showing campaign completion data flows, in accordance with an example embodiment of the present disclosure. The data flow paths of system 500 can be implemented by one or more algorithms, and are several of a large number of different data flow paths that can be implemented using the algorithms disclosed herein. The data flow paths allow data to be exchanged between two or more systems to allow described functions to be performed at a specific time and in a specific order, and thus present a significant improvement over prior art systems that only use a subset of the described functions or that fail to perform the described functions in the proper order and result in incomplete data sets and ineffective and wasteful use of resources.

Data flow path 502 can be formed by one or more algorithms and allows data to be exchanged between campaign completion system 132A and campaign tracking system 118, which are two of a large number of associated systems that can implement the disclosed algorithms. In one example embodiment, campaign completion system 132A can generate data that is provided to campaign tracking system 118 as it is entered by a user at influencer portal 104A, in response to a command executed by the user, upon completion of a campaign or in other suitable manners. In addition, campaign tracking system 118 can review the materials identified by campaign completion system 132A for compliance with campaign rules, can generate an alert for a user to review the materials identified by campaign completion system 132A for compliance with campaign rules and can perform other suitable functions.

Data flow path 504 can be formed by one or more algorithms and allows data to be exchanged between campaign tracking system 118 and campaign completion system 126A, which are two of a large number of associated systems that can implement the disclosed algorithms. In one example embodiment, campaign tracking system 118 can generate data that is provided to campaign completion system 126A as it is received by campaign tracking system 118, in response to a command executed by the user, upon completion of a campaign or in other suitable manners. In addition, campaign completion system 126A can review the materials identified by campaign tracking system 118 for compliance with campaign rules, can generate an alert for a user to review the materials identified by campaign tracking system 118 for compliance with campaign rules and can perform other suitable functions.

Data flow path 506 can be formed by one or more algorithms and allows data to be exchanged between campaign completion system 126A and social media website 108A, which are two of a large number of associated systems that can implement the disclosed algorithms. In one example embodiment, campaign completion system 126A can access social media website 108A to automatically determine compliance with campaign rules, a user at campaign completion system 126A can access social media website 108A to manually determine compliance or other suitable functions can also or alternatively be provided

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for data management comprising:
a campaign data management system operating on a first processor and configured to receive data identifying products and sales for each of a plurality of influencers;
a campaign creation system operating on the first processor and configured to receive a plurality of campaign rules from a user and to provide the plurality of campaign rules to the campaign data management system; and
wherein the campaign data management system is configured to identify a subset of the plurality of influencers as a function of the plurality of campaign rules and the data identifying products and sales and to provide the subset of the plurality of influencers to an influencer selection system operating on the first processor.

2. The system of claim 1 wherein the campaign data management system further comprises an influencer screening system operating on the first processor and configured to receive data identifying a plurality of influencers and to generate a control to allow a user to select one or more of the plurality of influencers.

3. The system of claim 1 wherein the campaign data management system further comprises an influencer sales tracking system operating on the first processor and configured to receive sales data associated with an influencer and to associate the sales data with an influencer campaign.

4. The system of claim 1 wherein the campaign data management system further comprises a brand portal hosting system operating on the first processor and configured to generate one or more controls to allow a user to define a plurality of performance criteria for a campaign for a selected influencer.

5. The system of claim 1 wherein the campaign data management system further comprises a campaign tracking system operating on the first processor and configured to generate one or more controls to allow a user to track the campaign for a selected influencer.

6. The system of claim 1 wherein the campaign data management system further comprises an influencer portal hosting system operating on the first processor and configured to generate one or more controls to allow a user to define an influencer portal for a selected influencer.

7. The system of claim 1 further comprising a plurality of brand portal systems each operating on one of a plurality of second processors, each of the second processors configured to receive campaign data for an associated brand and to generate one or more user controls for selecting campaign-related functions.

8. The system of claim 7 wherein the plurality of brand portal systems each comprises a campaign creation system operating on one of the plurality of second processors and configured to generate one or more user-selectable controls to allow a user to create a campaign for a brand.

9. The system of claim 7 wherein the plurality of brand portal systems each comprises an influencer selection system operating on one of the plurality of second processors and configured to generate one or more user-selectable controls to allow a user to select an influencer for a campaign for a brand.

10. The system of claim 7 wherein the plurality of brand portal systems each comprises a campaign completion system operating on one of the plurality of second processors and configured to generate one or more user-selectable controls to allow a user to evaluate campaign completion metrics for a brand and to change a status of a campaign to completed.

11. The system of claim 1 further comprising a plurality of influencer portal systems each operating on one of a plurality of second processors, each of the second processors configured to receive campaign status data and to generate one or more user controls identifying campaign completion metrics.

12. The system of claim 11 wherein the plurality of influencer portal systems each comprises a campaign posting system operating on one of the plurality of second processors and configured to receive campaign data and to generate one or more user controls identifying posted campaigns that are available to a user.

13. The system of claim 11 wherein the plurality of influencer portal systems each comprises a campaign tracking system operating on one of the plurality of second processors and configured to receive campaign status data and to generate one or more user controls identifying campaign tracking metrics.

14. The system of claim 11 wherein the plurality of influencer portal systems each comprises a campaign completion system operating on one of the plurality of second processors and configured to receive campaign status data and to generate one or more user controls identifying campaign completion metrics.
